(19) United States
(12) Patent Application Publication
(10) Pub. No.: US 2016/0345486 A1
(43) Pub. Date: Dec. 1, 2016

(54) System and Apparatus for Planting Seeds

(71) Applicant: Peter Simms, Gander (CA)

(72) Inventor: Peter Simms, Gander (CA)

(21) Appl. No.: 14/723,096

(22) Filed: May 27, 2015

(51) Int. Cl. A01C 7/02; A01C 21/00

(52) U.S. Cl. CPC A01C 7/02; A01C 21/00

(57) ABSTRACT

The present invention is a seeder apparatus having a main body a plurality of equally spaced openings in the main body, measurement indicia incorporated onto the main body, and a recessed slot constructed and arranged on said bottom surface.

### BACKGROUND OF THE INVENTION

A common problem amongst gardeners relates to the placement of seeds in a suitable position for growing. As much as persons try with measurement devices to ensure equal placement, there is invariably a degree of variation that many find unsuitable. Furthermore, prior attempts at presenting seed placement in a congruent manner results in greatly elongated planting times. The present invention addresses this difficulty.

### SUMMARY OF THE INVENTION

In one embodiment, the present invention is a seeder apparatus comprising:
a main body having a top surface and an opposing bottom surface, a width surface, and a height surface;
a plurality of equally spaced openings in said main body;
measurement indicia incorporated onto said main body; and
a recessed slot constructed and arranged on said bottom surface.

In one embodiment the main body is formed approximately 6 to 8 feet long, 1 to 2 inches wide and ½ to 1 inch tall. In one embodiment the plurality of equally spaced openings includes at least two adjacent rows of openings, whereby a first row has openings with a fixed and congruent radius and a second row has openings with a fixed and congruent radius different from said first row openings.

In one embodiment the measurement indicia is on said height surface.

Also contemplated is a method of planting seeds, said method comprising the steps of:
providing an apparatus according to the invention described herein;
placing the apparatus on a plating surface;
providing seeds to be planted;
positioning said seeds in selected openings;
planting seeds through said openings into said planting surface.

In one embodiment the method is further comprising the steps of: providing two apparatus according to the invention described herein with at least one connecting plate constructed and arranged to mate with said recessed slot; securing two seeder apparatus in an end to end arrangement by aligning said recessed slots along a single connecting plate; securing said connecting plate into a fixed position; continuing the method of of the invention at the step of positioning said secured two seeders on a planting surface.

In one embodiment of the present invention the apparatus will have the same shade of yellow paint on both sides of the seeder where the numbers presently are. Thus will greatly enhance the visibility of the numbers themselves.

In one embodiment of the present invention the apparatus will have the same number system in both sides of the seeder for reading or determining seed spacing for both sizes of seed ports.

The present invention is contemplated as a system and tool that will make the home and hobby gardener task of planting vegetable, and/or herb seeds etc. much more quick, simpler, efficient and accurate. It will also make the gardening experience more pleasant . . . especially the sometimes laborious task of seed planting by taking away the lengthy back bending and indeed the overall unhealthy body ergonomics required to properly place, line-up and insert seeds into the proper horizontal and even vertical spacing's as required by the many seed varieties that are utilized. It's a very user friendly and efficiently designed new tool for the “new and constant gardener”.

It is contemplated that a gardener can certainly cover a very large area very quickly and efficiently. Further the invention is suitable for covering a 5-10 acre area very effectively.

The actual efficiency of the time it takes to place seed, one by one, by hand, is at least four times slower placing seed, any type of seed, than using the present invention. And, the time it takes to line up seed in proper even rows is also made much more efficient. Overall placement of seed from beginning to end of process, using the present invention is cut down to 25%, minimum, from the previous laborious method.

In other words, what used to take say two hours to seed, takes only thirty minutes to do, and, at the same time having more accurately spaced seeds, straighter rows. This makes for more efficient usage of space in the garden layout in general.

### BRIEF DESCRIPTION OF THE SEVERAL VIEWS OF THE DRAWINGS

FIG. 1 demonstrates placement of an apparatus according to the present invention by a user.

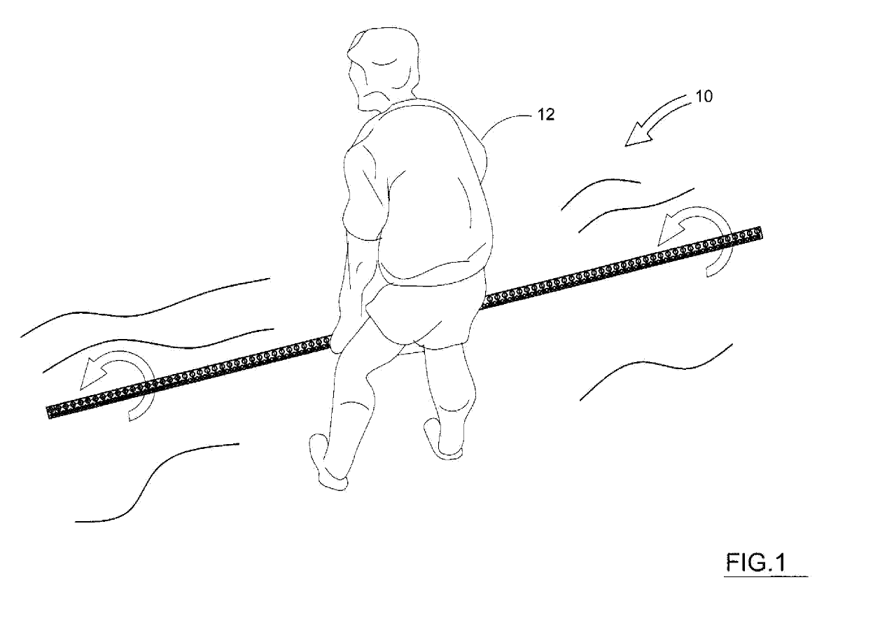

FIG. 2 is demonstrative of top, side, and bottom views of a cedar according to one embodiment of the present invention.

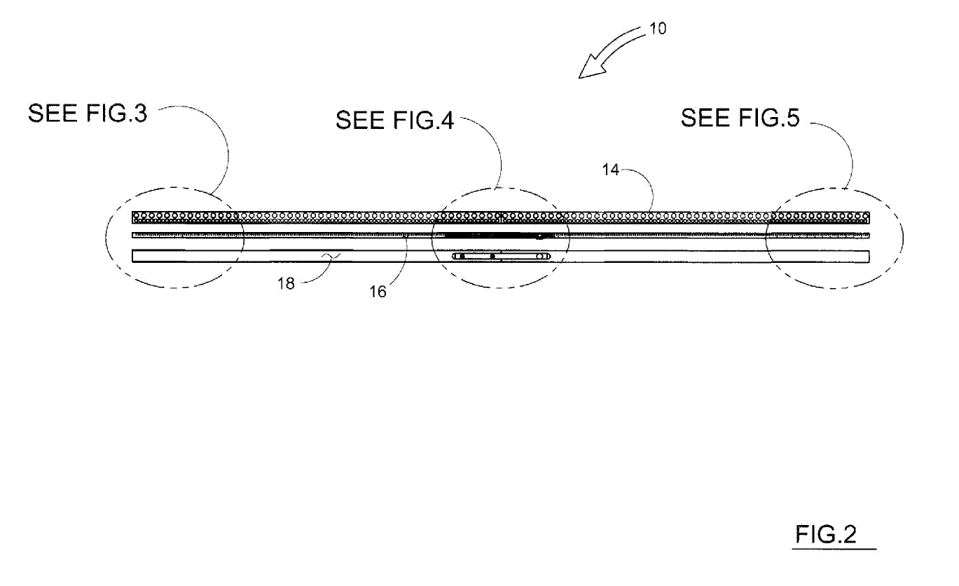

FIG. 3 is an enlarged partial view of the left end from FIG. 1.

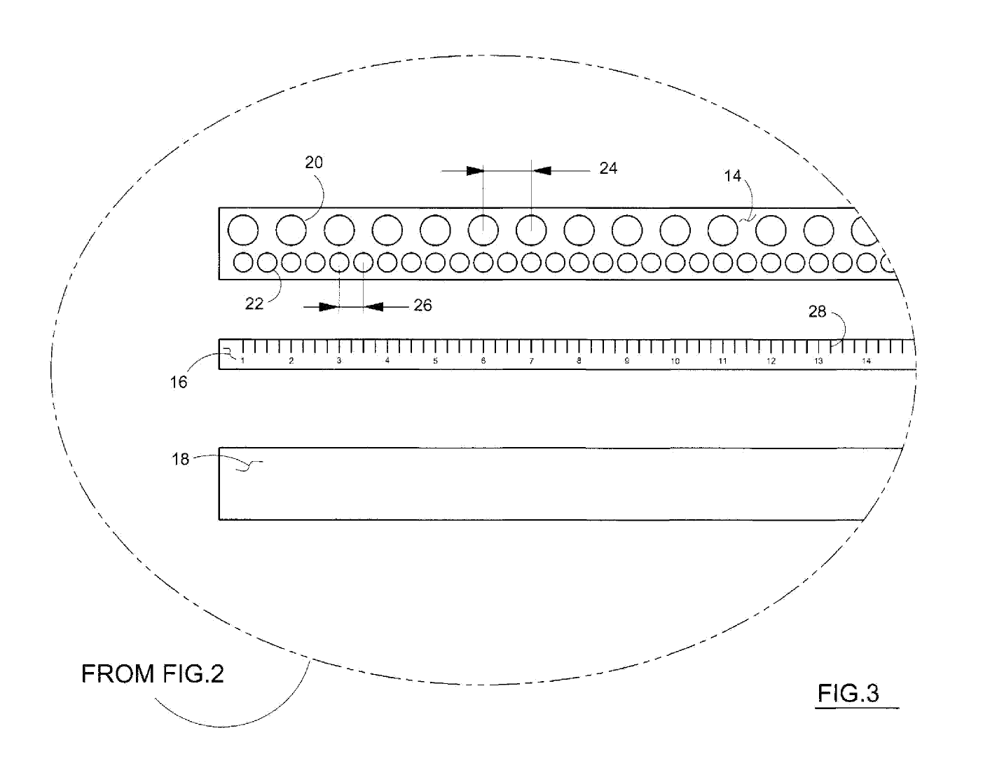

FIG. 4 is in a March partial view from the center portion of FIG. 1.

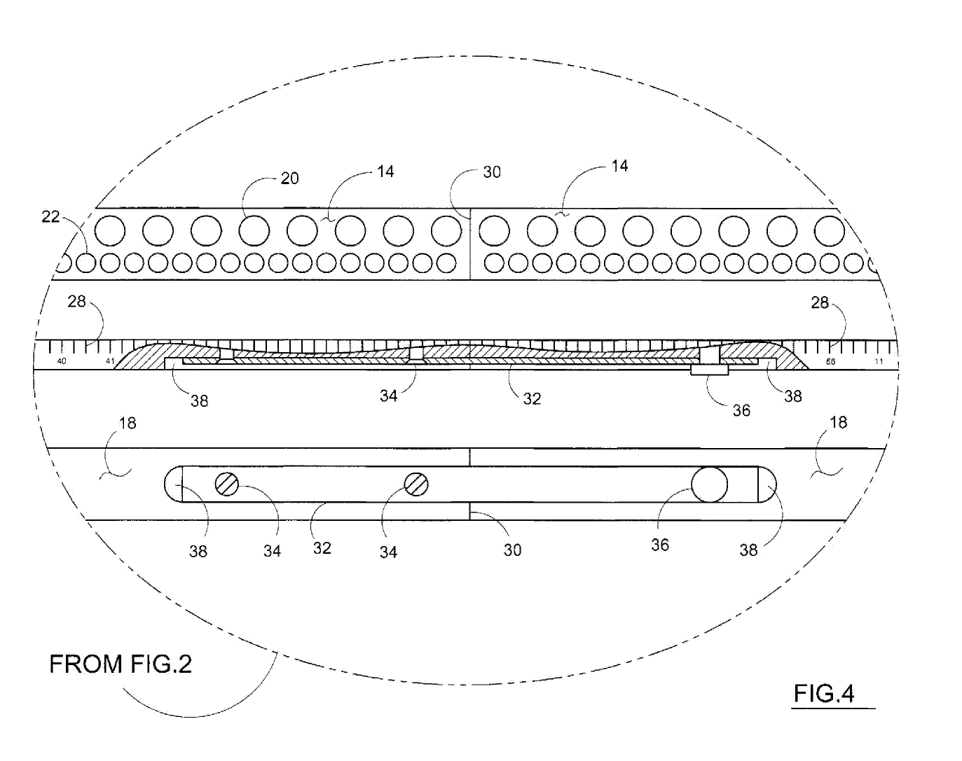

FIG. 5 is in a large partial view of the right and from FIG. 1.

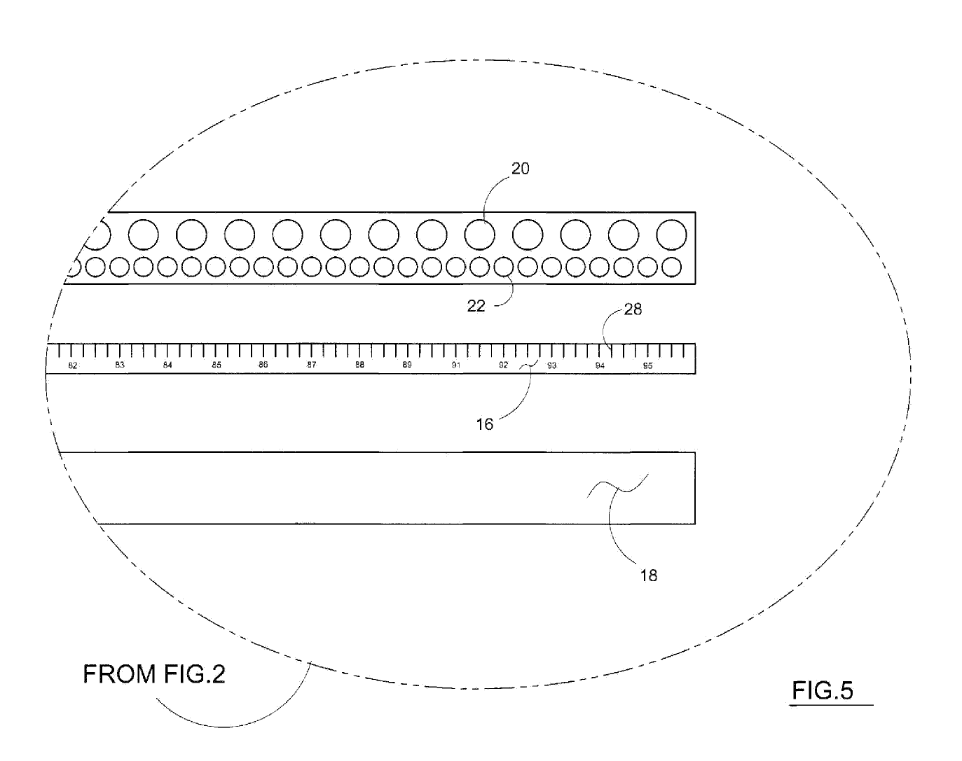

FIG. 6 is a perspective view demonstrating a connection system principal embodiment of the present invention.

### DETAILED DESCRIPTION OF THE PREFERRED EMBODIMENT

As generally understood, the present invention relates to a system and method for effectively, and efficiently planting seeds by hand. Seeder 10 is positioned by a user 12. Seeder 12 has a top surface 14, side surface 16, and bottom surface 18. In one embodiment, seed guide 10 is constructed and arranged with at least one of large seed placement holes 20, small seed placement holes 22, or combinations thereof. In an embodiment utilizing large placement holes 20 dimension 24 is representative of the distance from one center point to an adjacent center point of adjacent holes 20. Dimension 24 is contemplated at being between 0.5 and 1.5 inches. In a preferred embodiment, dimension 24 is approximately 1 inch. Dimension 26 is representative of the distance between one center point and an adjacent center point of small placement holes 22. Dimension 22 is contemplated as being between about 0.25 and 0.75 inches. In a preferred embodiment, dimension 26 is 0.5 inches. In one embodiment, seeder 10 has printed indicia 16 on one side whereby said printed indicia provide spacing measurement indicators 28.

In one embodiment, the present invention encompasses a system whereby two or more seeders 10 are joined at connection joint surface 30. A flathead screw 34 and thumb screw 36 interact with a recessed slot 38 constructed and arranged to join and secure seeder 10 in a continuous, connected arrangement.

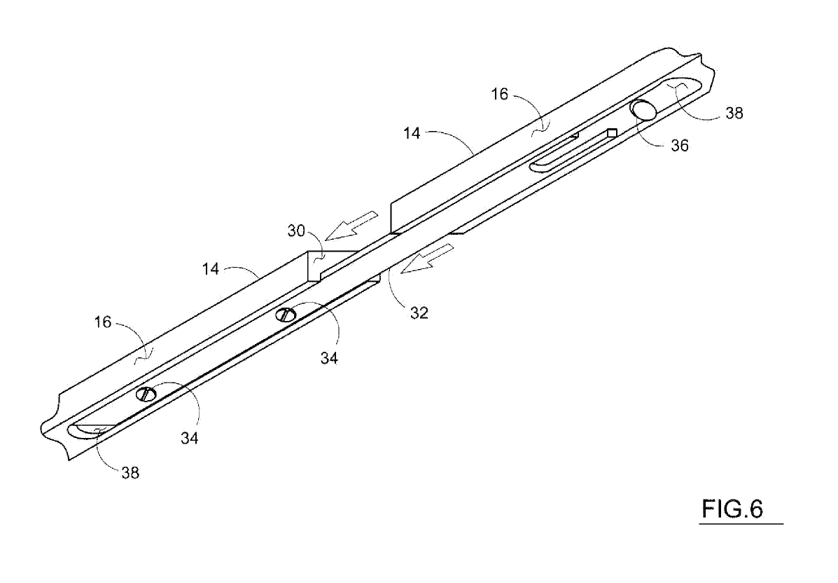

As best seen in FIG. 6 connection plate 32 is positioned into recessed slot 38 formed in seeder 10. Connection plate 32 is then secured to seeder 10 utilizing the aforementioned flathead screw 34 and, screw 36.

In one embodiment, seeder 10 is contemplated to be between six and 8 feet long, approximately 1 to 2 inches wide, and approximately ½ to 1 inch of depth. In another embodiment, seeder 10 is 8 feet long, 1 and ⅛ inches wide, and approximately ⅝ inches of depth. Measuring indicia 16 is utilized not only for seed spacing but further is utilized in measuring at least one of seed bed width, furrow width, furor depth, trench width, trench depth, alignment and measurement of potato eyes, seedlings, starter plants, combinations thereof and the like.

In one embodiment, a user will select seeder 10, position it as desired on the ground, or on any other surface in which seeds, (which includes seedlings, saplings, and the like) are to positioned and planted, and plant the desired seeds by inserting through selected seed placement holes using either large holes 20, or small holes 22 as desired.

In another embodiment, a user will connect two or more seeders 10 as demonstrated in FIG. 6, place on a surface for planting, select seeds for planting, and plant through either large holes 20 or small holes 22 as desired.

Further contemplated in the present invention is a system utilizing seeder 10 in conjunction with a drip irrigation system whereby irrigation is provided at specific and precise points to maximize irrigation and minimize the waste of irrigating water.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A seeder apparatus comprising:
a main body having a top surface and an opposing bottom surface, a width surface, and a height surface;
a plurality of equally spaced openings in said main body;
measurement indicia incorporated onto said main body; and
a recessed slot constructed and arranged on said bottom surface.

2. The seeder apparatus of claim 1 wherein said main body is formed approximately 6 to 8 feet long, 1 to 2 inches wide and ½ to 1 inch tall.

3. The seeder apparatus of claim 1 wherein said plurality of equally spaced openings includes at least two adjacent rows of openings, whereby a first row has openings with a fixed and congruent radius and a second row has openings with a fixed and congruent radius radius different from said first row openings.

4. The seeder apparatus of claim 1 wherein said measurement indicia is on said height surface.

5. A method of planting seeds, said method comprising the steps of:
providing an apparatus according to claim 1;
placing the apparatus on a plating surface;
providing seeds to be planted;
positioning said seeds in selected openings;
planting seeds through said openings into said planting surface.

6. The method of claim 5, further comprising the steps of:
providing two apparatus according to claim 1 with at least one connecting plate constructed and arranged to mate with said recessed slot; securing two seeder apparatus in an end to end arrangement by aligning said recessed slots along a single connecting plate; securing said connecting plate into a fixed position; continuing the method of claim 5 at the step of positioning said secured two seeders on a planting surface.
